(19) United States
(12) Patent Application Publication
(10) Pub. No.: US 2003/0159034 A1
(43) Pub. Date: Aug. 21, 2003

(54) Communication system, interconnecting device and program for authenticating a user of a communication network

(75) Inventor: Takayuki Sato, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(73) Assignee: ALLIED TELESIS K.K., Tokyo (JP)

(21) Appl. No.: 10/063,933

(22) Filed: May 28, 2002

(30) Foreign Application Priority Data
Feb. 19, 2002 (JP) 2002-41305

(51) Int. Cl. H04L 9/00

(52) U.S. Cl. 713/168

(57) ABSTRACT

A communication system that prevents improper or unauthorized use of a communication line by a user includes a first interconnecting device connected to a first communication device of a first network and a second interconnecting device, which is connected to the first interconnecting device and a second communication device of a second network, and controls whether or not communication between the first and second communication devices is allowed. A recording device, which is located outside the first interconnecting device, stores authentication information of a user of the first communication device. The authentication information is used by the second interconnecting device for authenticating the user. The first interconnecting device includes an acquiring unit for acquiring the authentication information and a transmit unit for transmitting the authentication information thus acquired to the second interconnecting device.

### CROSS REFERENCE TO RELATED APPLICATIONS

This patent application claims priority from a Japanese patent application No. 2002-041305 filed on Feb. 19, 2002, the contents of which are incorporated herein by reference.

### BACKGROUND OF INVENTION

1. Field of the Invention

The present invention relates to a communication system, an interconnecting device and a computer program. More particularly, the present invention relates to authentication of a communication network user to prevent improper or unauthorized use of a communication line by a user.

2. Description of the Related Art

With recent widespread home use of the Internet, it is expected that high-speed lines, e.g., broadband, capable of delivering a large volume of data, such as audio data, image data and movie data, via the Internet will be realized. In response to such demand, ADSL (Asymmetric Digital Subscriber Line), FTTH (Fiber To The Home) and the like have been offered to users who access the Internet via routers that can handle PPPoE (Point to Point over Ethernet) connections.

A conventional router that handles a PPPoE connection stores a user name and a password, which typically are set by a user, and access to the Internet, or other dedicated network, is obtained by transmitting the user name and password to an authentication apparatus of an Internet service provider in accordance with the user's instruction. Therefore, the conventional router has a problem or potential security problem in that the user's communication line, which is accessed by the router, may be used improperly by any user, whether authorized or not, by merely connecting through the router since the conventional router can access the communication line in accordance with the instruction of any user based upon the user name and password previously stored therein.

### SUMMARY OF INVENTION

Therefore, it is an object of the present invention to provide a communication system, an interconnecting device and a program stored in a computer-readable medium, which are capable of overcoming the above drawbacks accompanying the conventional art. The above and other objects can be achieved by combinations described in the independent claims. The dependent claims define further advantageous and exemplary combinations of the present invention.

According to a first aspect of the present invention, a communication system, that connects a first network and a second network for communication thereof, includes a first interconnecting device connected to a first communication device of the first network; a second interconnecting device, connected to the first interconnecting device and a second communication device of the second network, and operable to control whether or not communication between the first and second communication devices is allowed; and an external recording device operable to store authentication information of a user of the first communication device. The authentication information being used for authentication of the user by the second interconnecting device. The first interconnecting device includes an acquiring unit operable to acquire the authentication information of the user of the first communication device from the external recording device; and a transmit unit operable to transmit the authentication information acquired by the acquiring unit to the second interconnecting device.

The second interconnecting device includes a receive unit operable to receive the authentication information from the first interconnecting device; an authentication unit operable to authenticate the authentication information received by the receive unit; and a setting unit operable to set the second interconnecting device to allow the communication between the first and second communication devices, in a case where the authentication by the authentication unit was successful.

The acquiring unit of the first interconnecting device is further operable to acquire bandwidth information from the external recording device; the transmit unit of the first interconnecting device is further operable to transmit the bandwidth information acquired by the acquiring unit to the second interconnecting device; the receive unit of the second interconnecting device is further operable to receive the bandwidth information from the first interconnecting device; and the setting unit of the second interconnecting device is further operable to set a bandwidth of the communication between the first and second communication devices based on the bandwidth information received by the receive unit.

According to a second aspect of the present invention, an interconnecting device, for connecting a first network and a second network to enable communication between a first communication device of the first network and a second communication device of the second network, includes an acquiring unit operable to acquire from a recording device, which is outside the interconnecting device, authentication information of a user of the first communication device for authentication of the user, by an authentication apparatus, for controlling whether or not communication between the first and second communication devices is allowed; and a transmit unit operable to transmit the authentication information received by the acquiring unit to the authentication apparatus.

The acquiring unit includes a reading unit operable to read the authentication information from a non-volatile memory, as the recording device, storing the authentication information.

The acquiring unit includes a receive unit operable to perform wireless communication with a wireless communication device, as the recording device, storing the authentication information, and to receive the authentication information from the wireless communication device by the wireless communication.

The acquiring unit further acquires identification information of the authentication apparatus from the recording device, and the transmit unit transmits the authentication information acquired by the acquiring unit to the authentication apparatus identified by the identification information acquired by the acquiring unit.

The interconnecting device includes a setting unit operable to set a bandwidth of the communication between the first and second communication devices. The acquiring unit further acquires bandwidth information from the recording device, and the setting unit sets the bandwidth of the communication between the first and second communication devices based on the bandwidth information acquired by the acquiring unit.

The interconnecting device includes a decryption unit operable to decrypt encrypted authentication information in a case where the acquiring unit acquires the authentication information after encryption.

The interconnecting device includes a processing unit operable to determine whether or not the authentication apparatus is allowed to authenticate the user. The transmit unit transmits the authentication information acquired by the acquiring unit to the authentication apparatus when the processing unit determines that the authentication apparatus is allowed to authenticate the user.

The processing unit determines that the authentication apparatus is allowed to authenticate the user when the first communication device has been turned on.

The processing unit determines that the authentication apparatus is allowed to authenticate the user when the interconnecting device has been turned on.

According to a third aspect of the present invention, a program, stored in a computer-readable medium, for use in an interconnecting device that connects a first network and a second network to allow communication between a first communication device of the first network and a second communication device of the second network, includes an acquiring unit operable to acquire from a recording device, that is outside the interconnecting device, authentication information of a user of the first communication device, used for authentication of the user by an authentication apparatus for controlling whether or not communication between the first and second communication devices is allowed; and a transmit unit operable to transmit the authentication information to the authentication apparatus.

The program includes a setting unit operable to set a bandwidth of the communication between the first and second communication devices. The acquiring unit further operates to acquire bandwidth information from the recording device, and the setting unit operates to set the bandwidth of the communication between the first and second communication devices based on the bandwidth information.

The program includes a decryption unit operable to decrypt encrypted authentication information when the authentication information is encrypted.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF DRAWINGS

FIG. 1 illustrates an exemplary structure of a communication system 100 according to an embodiment of the present invention.

FIG. 2 illustrates a first exemplary structure of an interconnecting device 10a according to one embodiment of the present invention.

FIG. 3 illustrates a second exemplary structure of an interconnecting device 10a according to one embodiment of the present invention.

FIG. 4 illustrates an exemplary structure of an interconnecting device 40 according to one embodiment of the present invention.

FIG. 5 shows an operation flow of the communication system 100 according to one embodiment of the present invention.

FIG. 6 illustrates a hardware configuration of PC 20a according to one embodiment of the present invention.

### DETAILED DESCRIPTION

The invention will now be described based on the preferred embodiments, which do not intend to limit the scope of the present invention, but exemplify the invention. All of the features and the combinations thereof described in the embodiments are not necessarily essential to the invention.

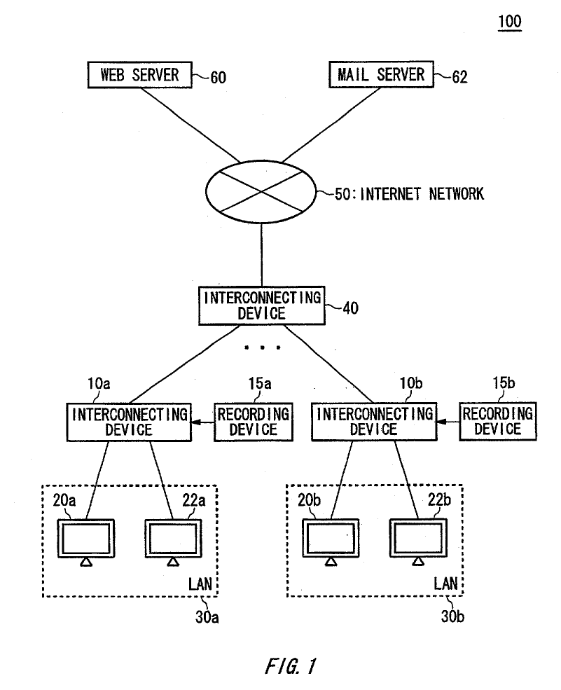

FIG. 1 illustrates an exemplary structure of a communication system 100 according to an embodiment of the present invention. The communication system 100 includes interconnecting devices 10a and 10b; recording devices 15a and 15b; personal computers (PCs) 20a, 22a, 20b and 22b, as examples of communication devices; an interconnecting device 40; a network 50, such as the Internet; a server 60, such as a Web server; and a server 62, such as a mail server. The interconnecting device 10a connects PCs 20a and 22a to the interconnecting device 40. The interconnecting device 10b connects PCs 20b and 22b to the interconnecting device 40. The interconnecting device 40 connects the interconnecting devices 10a and 10b to the network 50, e.g., the Internet.

PCs 20a and 22a form LAN 30a while PCs 20b and 22b form LAN 30b. LANs 30a and 30b are an exemplary first network according to one embodiment of the present invention. The network 50 is an exemplary second network according to one embodiment of the present invention. Moreover, PCs 20a, 22a, 20b and 22b are examples of the first communication device according to one embodiment of the present invention. The server 60 and the server 62 are exemplary second communication devices according to one embodiment of the present invention. The interconnecting device 40 serves as an example of an authentication apparatus according to one embodiment of the present invention.

The recording device 15a stores authentication information used for authentication, by the interconnecting device 40, of a user of the interconnecting device 10a (i.e., a user of PC(s) 20a and/or 22a). The recording device 15a provides the authentication information to the interconnecting device 10a. Also, the recording device 15b stores authentication information used for authentication of a user of the interconnecting device 10b (i.e., a user of PC(s) 20b and/or 22b) by the interconnecting device 40, and provides the authentication information to the interconnecting device 10b. The recording devices 15a and 15b may be a non-volatile memory, such as an IC card, a miniature card, or a floppy disk, or a wireless communication device capable of performing wireless communication, such as IrDA. Moreover, it is desirable that the recording devices 15a and 15b store encrypted authentication information.

The interconnecting device 10a obtains the authentication information to be used for authentication of the user of the interconnecting device 10a, by the interconnecting device 40, from the recording device 15a. The interconnecting device 10a then transmits the authentication information to the interconnecting device 40 in accordance with a user's instruction in order to connect LAN 30a to the Internet network 50. Similarly, the interconnecting device 10b obtains the authentication information to be used for authentication of the user of the interconnecting device 10b, by the interconnecting device 40, from the recording device 15b. The interconnecting device 10b then transmits the authentication information to the interconnecting device 40 in accordance with a user's instruction in order to connect LAN 30b to the Internet network 50.

For example, in an embodiment where the interconnecting devices 10a and 10b are connected to the interconnecting device 40 by PPPoE connection, each of the interconnecting devices 10a and 10b acquires a name and a password of the corresponding user as the authentication information from the associated recording device 15a or 15b and then transmits the acquired information to the interconnecting device 40. In another embodiment where the interconnecting devices 10a and 10b are connected to the interconnecting device 40 by dial-up connection, each of the interconnecting devices 10a and 10b acquires a destination phone number, the user name and the password as the authentication information from the associated recording device 15a or 15b and then transmits the acquired authentication information to the interconnecting device 40.

The interconnecting device 40 controls whether or not the interconnecting devices 10a and 10b are connected to the Internet network 50. In other words, the interconnecting device 40 controls whether or not communication is allowed between each of PCs 20a, 22a, 20b and 22b and the Web server 60 and mail server 62.

The interconnecting device 40 authenticates the authentication information received from the interconnecting device 10a or 10b. In a case where authentication of the information received from the interconnecting device 10a was successful, the interconnecting device 40 enables communication between LAN 30a and the Internet network 50. Thus, PCs 20a and 22a of LAN 30a can be connected to the Internet network 50 and therefore the user(s) of PCs 20a and 22a can use the Web server 60 and the mail server 62. Also, the interconnecting device 40 enables communication between LAN 30b and the Internet network 50 in a case where authentication of the information received from the interconnecting device 10b was successful. Thus, PCs 20b and 22b can be connected to the Internet network 50 and therefore the user(s) of PCs 20b and 22b can use the Web server 60 and the mail server 62.

In the above description, the interconnecting device 40 authenticates only the authentication information received from the interconnecting devices 10a and 10b. However, the present invention is not limited thereto. The authentication may be performed by an external authentication apparatus connected to the interconnecting device 40. Moreover, the interconnecting device 40 and the external authentication apparatus may be connected directly to each other so as to allow communication there between, or may communicate with each other via the Internet network 50.

An Internet provider for managing the interconnecting device 40 provides the user, who signed up with the Internet provider for a communication line, with the interconnecting device 10a and the recording device 15a as a package or set, or the interconnecting device 10b and the recording device 15b as a package or set. The recording device 15a stores authentication information encrypted by the Internet provider, while the associated interconnecting device 10a has a decryption key used for decrypting the authentication information stored in the recording device 15a. Similarly, the recording device 15b stores authentication information encrypted by the Internet provider, while the associated interconnecting device 10b has a decryption key used for decrypting the authentication information stored in the recording device 15b.

Thus, only the user who owns (i.e., possesses) the recording device 15a can access the Internet network 50 by means of the interconnecting device 10a. Similarly, only the user who owns (i.e., has possession of) the recording device 15b can access the Internet network 50 by means of the interconnecting device 10b. More specifically, the user of PC 20a or 22a owns, as a key for accessing the Internet network 50 via the interconnecting device 10a, the recording device 15a that stores authentication information for the user of the interconnecting device 10a. The user can access the Internet network 50 by using PC 20a or 22a by causing the interconnecting device 10a to acquire the authentication information stored in the recording device 15a. Similarly, the user of PC 20b or 22b owns, as a key for accessing the Internet network 50 via the interconnecting device 10b, the recording device 15b that stores authentication information for the user of the interconnecting device 10b. The user can access the Internet network 50 by using PC 20b or 22b by causing the interconnecting device 10b to acquire the authentication information stored in the recording device 15b. Moreover, since the recording devices 15a and 15b store the authentication information after being encrypted, disclosure or loss of the user's authentication information can be prevented.

According to the communication system 100 of the present embodiment, only the user who owns the recording device 15a can access the Internet network 50 via the interconnecting device 10a. Thus, it is possible to prevent an unfair use of the communication line by a user other than the user who owns the recording device 15a (that is, the user of the interconnecting device 10a who signed up for the communication line). Similarly, since only the user who owns the recording device 15b can access the Internet network 50 via the interconnecting device 10b, an unfair use of the communication line by a user other than the user who owns the recording device 15b (that is, the user of the interconnecting device 10b who signed up for the communication line) can be prevented.

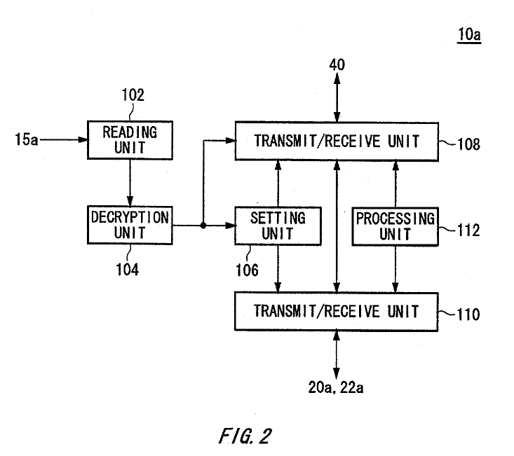

FIG. 2 illustrates a first example of the structure of the interconnecting device 10a according to one embodiment of the present invention. The interconnecting device 10b has the same structure as the interconnecting device 10a and therefore only the interconnecting device 10a is described as a typical example.

The interconnecting device 10a of the first example of the present embodiment includes: a reading unit 102 serving as an exemplary acquiring unit operable to acquire authentication information for allowing the interconnecting device 40 to authenticate the user of the interconnecting device 10a; a decryption unit 104 operable to decrypt the encrypted authentication information; a setting unit 106 operable to perform various settings related to communication in the interconnecting device 10a; a transmit/receive unit 108 operable to transmit data to the interconnecting device 40 and receive data from the interconnecting device 40; a transmit/receive unit 110 operable to transmit data to PCs 20a and 22a and receive data from PCs 20a and 22a; and a processing unit 12 operable to determine whether or not the authentication of the user of the interconnecting device 10a by the interconnecting device 40 is allowed.

The reading unit 102 holds the recording device 15a inserted thereto by the user of the interconnecting device 10a, that is a non-volatile memory, such as an IC card, a miniature card or a floppy disk, for storing authentication information of the user of the interconnecting device 10a. The reading unit 102 then reads out the authentication information from the non-volatile memory serving as the recording device 15a. The decryption unit 104 decrypts the authentication information read by the reading unit 102 in a case where the authentication information thus read was encrypted. The external transmit/receive unit 108 then transmits the authentication information decrypted by the decryption unit 104 to the interconnecting device 40.

The processing unit 112 determines whether or not the interconnecting device 40 is allowed to authenticate the user of the interconnecting device 10a. In other words, the processing unit 112 determines whether or not the transmission of the authentication information by the transmit/receive unit 108 is allowed. More specifically, the processing unit 112 may detect whether or not PC 20a or 22a which is connected to the transmit/receive unit 110 has been turned on, so as to allow the authentication of the user of the interconnecting device 10a by the interconnecting device 40 in a case where it was detected that PC 20a or 22a had been turned on.

Moreover, the processing unit 112 may detect whether or not the interconnecting device 10a has been turned on, so as to allow the authentication of the user of the interconnecting device 10a by the interconnecting device 40 in a case where it was detected that the interconnecting device 10a had been turned on.

Furthermore, the processing unit 112 may detect whether or not the transmit/receive unit 110 received a packet from PC 20a or 22a, so as to allow the authentication of the user of the interconnecting device 10a by the interconnecting device 40 in a case where the transmit/receive unit 110 received the packet. In this case, the transmit/receive unit 108 may transmit the authentication information read by the reading unit 102 from the recording device 15a, that is the non-volatile memory, to the interconnecting device 40.

The reading unit 102 may further read identification information of the interconnecting device 40 from the recording device 15a, which may be a non-volatile memory. In this case, the transmit/receive unit 108 may transmit the authentication information read from the recording device 15a to the interconnecting device 40 that is identified by the identification information read from the recording device 15a. In this way, it is possible to easily access any of a plurality of interconnecting devices 40 (that is, a plurality of Internet providers) by means of a single interconnecting device 10a, thus allowing change of the Internet provider depending on the service type of the communication line.

The reading unit 102 may further read from the recording device 15a, which may be a non-volatile memory, bandwidth information that describes a bandwidth in which the interconnecting device 10a can communication with the interconnecting device 40. In this case, the setting unit 106 may set the bandwidth of communication between PCs 20a and 22a and the interconnecting device 40, that is, the bandwidth that can be used for communication between PCs 20a and 22a and the Web server 60 and mail server 62, based on the bandwidth information read by the reading unit 102 from the recording device 15a. More specifically, the setting unit 106 may limit the bandwidth of the communication between the interconnecting device 40 and the transmit/receive unit 108 of the interconnecting device 10a or the bandwidth of the communication between PCs 20a and 22a and the transmit/receive unit 110 of the interconnecting device 10a. Thus, the manager of the interconnecting device 40 (that is, the Internet provider) can easily set the bandwidth of communication that can be used by the user of the interconnecting device 10a. Moreover, the transmit/receive unit 108 may transmit the bandwidth information read by the reading unit 102 from the recording device 15a, to the interconnecting device 40.

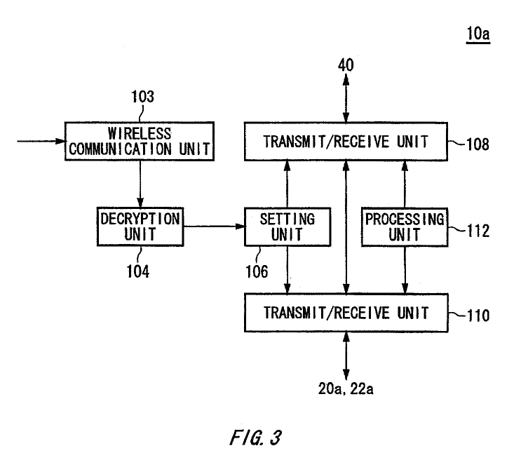

FIG. 3 illustrates a second example of the interconnecting device 10a of the present embodiment. The same components as those in the first exemplary interconnecting device 10a shown in FIG. 2 are labeled with the same reference numerals. In addition, a description of the same structure and operations as those in the first example shown in FIG. 2 is partially omitted, and the structure and operations that are different from those in the first example shown in FIG. 2 are particularly described below.

The interconnecting device 10a according to the second example of the present embodiment includes a wireless communication unit 103 in place of the reading unit 102 of the first exemplary interconnecting device 10a. The wireless communication unit 103 receives, by wireless communication, authentication information of the user of the interconnecting device 10a from the recording device 15a, which may be a wireless communication device storing the authentication information. The wireless communication unit 103 may further read identification information of the interconnecting device 40 from the recording device 15a.

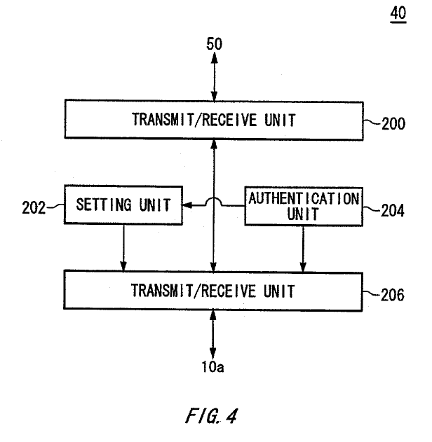

FIG. 4 illustrates an exemplary structure of the interconnecting device 40 of the present embodiment. The interconnecting device 40 includes an authentication unit 204 operable to perform authentication of the user of the interconnecting device 10a, a transmit/receive unit 206 operable to transmit data to the interconnecting device 10a and receive data from the interconnecting device 10a, a transmit/receive unit 200 operable to transmit data to the Internet network 50 and receive data from the Internet network 50, and a setting unit 202 operable to perform various settings related to communication in the interconnecting device 40.

The transmit/receive unit 206 receives authentication information of the user from the interconnecting device 10a. The authentication unit 204 then performs authentication for the authentication information received by the transmit/receive unit 206 from the interconnecting device 10a. In a case where the authentication was successful, the setting unit 202 sets the interconnecting device 40 to permit communication between the interconnecting device 10a and the Internet network 50.

The transmit/receive unit 206 may further receive bandwidth information from the interconnecting device 10a. In this case, the setting unit 202 may set the bandwidth of the communication between the interconnecting device 10a and the Internet network 50, that is, the bandwidth of communication between the PCs 20a and 22a and the Web server 60 and mail server 62, based on the bandwidth information received by the transmit/receive unit 206. More specifically, the setting unit 202 may limit the bandwidth of the communication at a port of the transmit/receive unit 206 to which the interconnecting device 10a is connected. In this way, the manager of the interconnecting device 40 (that is, the Internet provider) can easily set the bandwidth of the communication used by the user of the interconnecting device 10a.

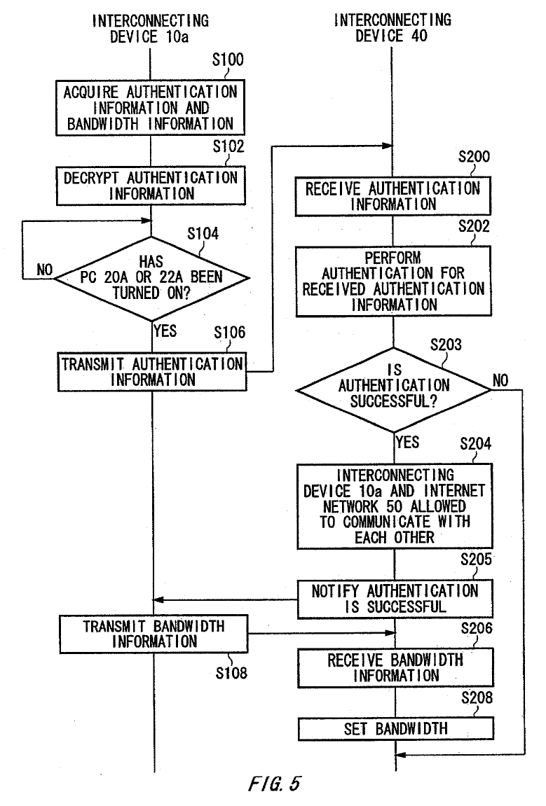

FIG. 5 shows an exemplary operation flow of the communication system 100 according to the present embodiment. First, in the interconnecting device 10a, the reading unit 102 shown in FIG. 2 or the wireless communication unit 103 shown in FIG. 3 acquires encrypted authentication information and bandwidth information from the recording device 15a (Step S100). The decryption unit 104 decrypts the authentication information acquired from the recording device 15a (Step S102). The processing unit 112 monitors whether or not PC 20a or 22a has been turned on (Step S104). In a case where PC 20a or 22a is on, the transmit/receive unit 108 transmits the authentication information to the interconnecting device 40 (Step S106).

Then, in the interconnecting device 40, the transmit/receive unit 206 receives the authentication information transmitted from the interconnecting device 10a (Step S200). The authentication unit 204 performs authentication for the authentication information received by the transmit/receive unit 206 (Step S202). In a case where the authentication by the authentication unit 206 was not successful (Step S203-N), the interconnecting device 40 does not permit the communication between the interconnecting device 10a and the Internet network 50, and the operation flow of the communication system 100 is finished. In another case where the authentication by the authentication unit 206 was successful (Step S203-Y), the setting unit 202 sets the interconnecting device 40 to allow the communication between the interconnecting device 10a and the Internet network 50 (Step S204). The transmit/receive unit 206 then notifies the interconnecting device 10a that the authentication was successful by transmitting information describing that fact (Step S205).

Next, in the interconnecting device 10a, the transmit/receive unit 108 transmits the bandwidth information to the interconnecting device 40 (Step S108). In the interconnecting device 40, the transmit/receive unit 206 receives the bandwidth information transmitted from the interconnecting device 10a (Step S206). The setting unit 202 then sets the bandwidth of the communication between the interconnecting device 10a and the Internet network 50 based on the bandwidth information received by the transmit/receive unit 206 (Step S208). Thus, PCs 20a and 22a can communicate with the Web server 60 and mail server 62 through the Internet network 50. In this way, the operation flow of the communication system 100 is finished.

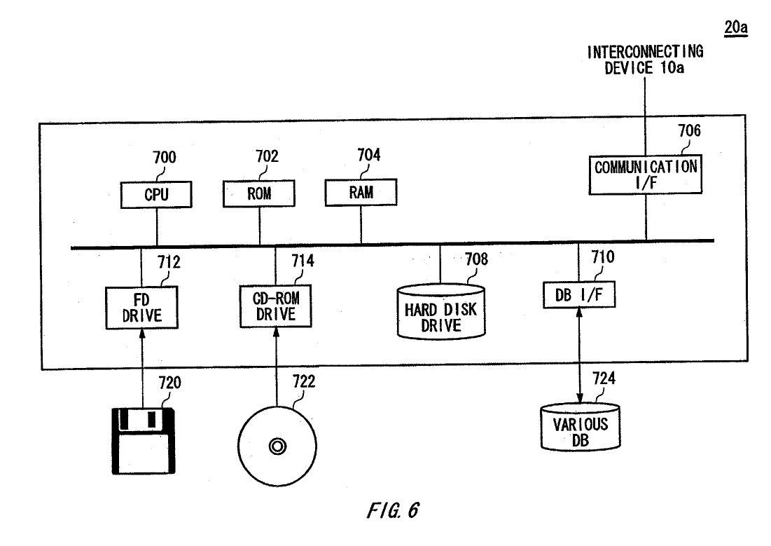

FIG. 6 illustrates an exemplary hardware configuration of PC 20a according to one embodiment of the present invention. PC 20a includes a CPU 700, a ROM 702, a RAM 704, a communication interface 706, a hard disk drive 708, a database interface 710, a floppy disk drive 712 and a CD-ROM drive 714. CPU 700 operates based on at least one program stored in the ROM 702 and/or RAM 704. The communication interface 706 communicates with the interconnecting device 10a through a computer network, for example. The database interface 710 writes data into a database and updates the contents of the database.

The floppy disk drive 712 reads data or program from a floppy disk 720 to provide the read data or program to the communication interface 706. The CD-ROM drive 714 reads data or program from a CD-ROM 722 to provide the read data or program to the communication interface 706. The communication interface 706 transmits the data or program provided by the floppy disk drive 712 or CD-ROM drive 714 to the interconnecting device 10a. The database interface 710 can be connected to various types of database 724 to perform data transmission and data receiving therewith.

The program provided to the interconnecting device 10a is provided by a user while being stored in a recording medium such as the floppy disk 720 or the CD-ROM 722. The program stored in the recording medium maybe compressed or not-compressed. The program is read from the recording medium to be installed into the interconnecting device 10a via the communication interface 706, so that the interconnecting device 10a executes the program.

The program provided while being stored in the recording medium, that is the program to be installed into the interconnecting device 10a, makes the interconnecting device 10a serve as a reading unit, a wireless communication unit, a decryption unit, a setting unit, a first transmit/receive unit, a second transmit/receive unit and a processing unit. The functions of the respective units are the same as the operations of the corresponding units in the interconnecting device 10a described referring to FIGS. 1-3 and 5, and therefore a description is omitted here.

A part or all of the functions and operations of the interconnecting device 10a according to all the embodiments described herein can be stored in the floppy disk 720 or the CD-ROM 722 shown in FIG. 6 as examples of the recording medium.

These programs may be read directly into the interconnecting device 10a from the recording medium to be executed therein, or may be executed in the interconnecting device 10a after the programs are installed into the interconnecting device 10a. Moreover, the above-mentioned programs may be stored in a single recording medium or a plurality of recording media. Furthermore, the programs may be stored while being encoded.

As a recording medium, other than the floppy disk and the CD-ROM, an optical recording medium such as a DVD or a PD, a magneto-optical recording medium such as an MD, a tape-like medium, a magnetic recording medium, or a semiconductor memory, such as an IC card or a miniature card, can be used. Moreover, a storage device such as a hard disk or a RAM provided in a server system connected to an exclusive communication network or the Internet may be used as the recording medium, so that the program can be provided to the interconnecting device 10a through a communication network.

According to the present invention as described above, improper use of a network by a user who does not have possession of authentication information, which is stored in an external recording medium, can be prevented.

Although the present invention has been described by way of exemplary embodiments, it should be understood that those skilled in the art might make many changes and substitutions without departing from the spirit and the scope of the present invention which is defined only by the appended claims.

1. A communication system that connects a first network and a second network for communication thereof, comprising:
a first interconnecting device connected to a first communication device of said first network;
a second interconnecting device, connected to said first interconnecting device and a second communication device of said second network, operable to control whether or not communication between said first and second communication devices is allowed; and
an external recording device connecting to said first interconnecting device and operable to store authentication information of a user of said first communication device, said authentication information being used for authentication of the user by said second interconnecting device, wherein said first interconnecting device comprises:
an acquiring unit operable to acquire said authentication information of the user of said first communication device from said external recording device; and
a transmit unit operable to transmit said authentication information acquired by said acquiring unit to said second interconnecting device.

2. A communication system as claimed in claim 1, wherein said second interconnecting device includes:
a receive unit operable to receive said authentication information from said first interconnecting device;
an authentication unit connecting to said receive unit and operable to authenticate said authentication information received by said receive unit; and
a setting unit connecting to said authentication unit and operable to set said second interconnecting device to allow the communication between said first and second communication devices in a case where the authentication by said authentication unit was successful.

3. A communication system as claimed in claim 2, wherein said acquiring unit of said first interconnecting device is further operable to acquire bandwidth information from said external recording device;
said transmit unit of said first interconnecting device is further operable to transmit said bandwidth information acquired by said acquiring unit to said second interconnecting device;
said receive unit of said second interconnecting device is further operable to receive said bandwidth information from said first interconnecting device; and
said setting unit of said second interconnecting device is further operable to set a bandwidth of the communication between said first and second communication devices based on said bandwidth information received by said receive unit.

4. An interconnecting device for connecting a first network and a second network to enable communication between a first communication device of said first network and a second communication device of said second network, the interconnecting device comprising:
an acquiring unit operable to acquire from a recording device, which is outside said interconnecting device, authentication information of a user of said first communication device for authentication of the user, by an authentication apparatus, for controlling whether or not communication between said first and second communication devices is allowed; and
a transmit unit connecting to said acquiring unit and operable to transmit said authentication information received by said acquiring unit to said authentication apparatus.

5. An interconnecting device as claimed in claim 4, wherein said acquiring unit comprises a reading unit operable to read said authentication information from a non-volatile memory that comprises said recording device storing said authentication information.

6. An interconnecting device as claimed in claim 4, wherein said acquiring unit includes a receive unit operable to perform wireless communication with a wireless communication device that comprises said recording device storing said authentication information, and to receive said authentication information from said wireless communication device by the wireless communication.

7. An interconnecting device as claimed in claim 4, wherein said acquiring unit further acquires identification information of said authentication apparatus from said recording device, and said transmit unit transmits said authentication information acquired by said acquiring unit to said authentication apparatus identified by said identification information acquired by said acquiring unit.

8. An interconnecting device as claimed in claim 4, further comprising a setting unit connecting to said acquiring unit and operable to set a bandwidth of the communication between said first and second communication devices, wherein
said acquiring unit further acquires bandwidth information from said recording device, and
said setting unit sets said bandwidth of the communication between said first and second communication devices based on said bandwidth information acquired by said acquiring unit.

9. An interconnecting device as claimed in claim 4, further comprising a decryption unit connecting to said acquiring unit and operable to decrypt encrypted authentication information in a case where said acquiring unit acquired said authentication information after encryption.

10. An interconnecting device as claimed in claim 4, further comprising a processing unit connecting to said transmit unit and operable to determine whether or not said authentication apparatus is allowed to authenticate the user, wherein
said transmit unit transmits said authentication information acquired by said acquiring unit to said authentication apparatus in a case where said processing unit determined that said authentication apparatus is allowed to authenticate the user.

11. An interconnecting device as claimed in claim 10, wherein said processing unit determines that said authentication apparatus is allowed to authenticate the user in a case where said first communication device has been turned on.

12. An interconnecting device as claimed in claim 10, wherein said processing unit determines that said authentication apparatus is allowed to authenticate the user in a case where said interconnecting device has been turned on.

13. A program, stored in a computer-readable medium, for use in an interconnecting device that connects a first network and a second network to allow communication between a first communication device of said first network and a second communication device of said second network, the program comprising:
an acquiring unit operable to acquire from a recording device, that is outside said interconnecting device, authentication information of a user of said first communication device, used for authentication of the user by an authentication apparatus for controlling whether or not communication between said first and second communication devices is allowed; and
a transmit unit operable to transmit said authentication information to said authentication apparatus.

14. A program as claimed in claim 13, further comprising a setting unit operable to set a bandwidth of the communication between said first and second communication devices, wherein
said acquiring unit further operates to acquire bandwidth information from said recording device, and
said setting unit operates to set the bandwidth of the communication between said first and second communication devices based on said bandwidth information.

15. A program as claimed in claim 13, further comprising a decryption unit operable to decrypt encrypted authentication information when said authentication information is encrypted.
